(19) United States
(12) Patent Application Publication
(10) Pub. No.: US 2016/0092881 A1
(43) Pub. Date: Mar. 31, 2016

(54) SYSTEMS AND METHODS TO FACILITATE PRODUCT MANAGEMENT

(71) Applicant: Registria, Inc., Palo Alto, CA (US)

(72) Inventors: Kelly Forese, Atherton, CA (US); Preston Stuteville, Yale, OK (US); Sunil Karkera, San Jose, CA (US)

(21) Appl. No.: 14/500,231

(22) Filed: Sep. 29, 2014

(51) Int. Cl. G06Q 30/00

(52) U.S. Cl. CPC G06Q 30/012

(57) ABSTRACT

Systems and methods for facilitating product management can associate a code with product information and a product life-cycle. The code can be associated with a product and affixed to the product, for example, by printing the code on the product or a packing of the product. Users of the product can initiate an action included in the product life-cycle by using an electronic device to take a picture of the code texting the picture to the disclosed system. The system will process the code and determine a next action in the product life-cycle. For example, a user can take an image of a code and text it to the system to initiate a product registration process.

### SUMMARY

This disclosure generally relates to systems and method to facilitate product management. In particular, certain examples relate to systems and methods that use a code associated with a product life-cycle to streamline product management. As will be discussed herein, features disclosed can provide for a reduction in cycle time, ease of use for the user, as well as time and cost savings.

### BRIEF DESCRIPTION OF THE DRAWINGS

The following drawings are illustrative of particular embodiments of the invention and therefore do not limit the scope of the invention. The drawings are not necessarily to scale, unless so stated. The drawings are intended for use in conjunction with the explanations in the following detailed description. Embodiments of the invention will hereinafter be described in conjunction with the appended drawings, wherein like numerals denote like elements.

FIG. 1 is a block diagram illustrating a system for facilitating product management.

FIG. 2 is a flow diagram of a method for facilitating product management.

FIGS. 3A-3E illustrate examples of tags including codes that can be used to facilitate product management.

FIG. 4 is flow diagram illustrating examples of a product life-cycle.

FIG. 5 is a flow diagram of a method for an action directed to providing product registration.

FIG. 6 is a flow diagram of a method for an action directed to providing product updates.

### DETAILED DESCRIPTION

The following detailed description is exemplary in nature and is not intended to limit the scope, applicability, or configuration of the invention in any way. Rather, the following description provides some practical illustrations for implementing exemplary embodiments of the present invention. Examples of constructions, materials, and processes are provided for selected elements, and all other elements employ that which is known to those of ordinary skill in the field of the invention. Those skilled in the art will recognize that many of the noted examples have a variety of suitable alternatives.

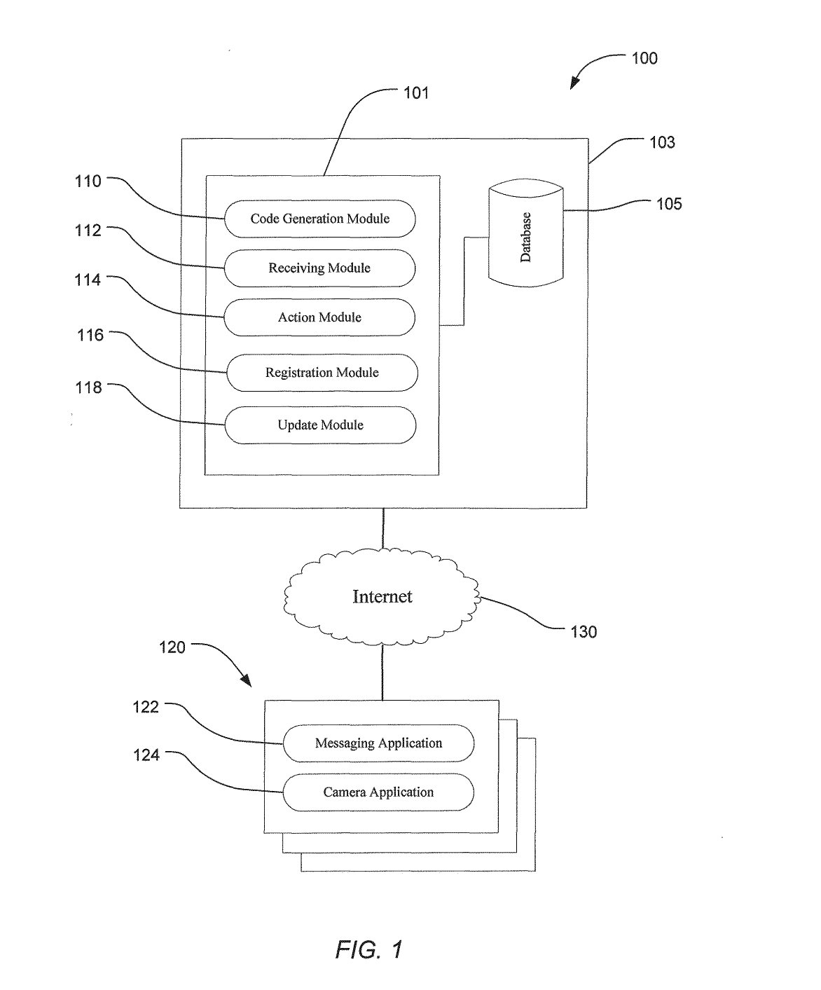

FIG. 1 is a block diagram illustrating a system 100 for facilitating product management. System 100 includes a computing platform 103. Examples of computing platform 103 can include any suitable computing device including, but not limited to, a server. Computing platform 103 can include a computer storage medium 101 and database 105. Database 105 can be adapted to store product management data including, for example, product information. some examples, system 100 may include one or more databases. Computer storage medium 101 can include one or more program modules adapted to execute on one or more processors (not shown). In some examples, a program module can comprise computer readable instructions adapted direct one or more processors to perform a specific task and/or facilitate a particular action. Examples of program modules include code generation module 110, receiving module, 112, action module, 114, registration module 116, and update module 118. These program modules, and others, are discussed in further detail below. In some examples, computer storage medium 101 can include any combination of the listed program modules and/or any unspecified program modules as necessary to facilitate product management.

System 100 can include one or more electronic devices 120. In some examples, electronic devices 120 are mobile devices including, but not limited to, smart phones, tablets, scanners, and/or laptops. In some examples, some or all of the electronic devices 120 can include a messaging application 122 and a camera application 124.

Camera application 124 can be adapted to capture and generate an image. In some examples, in addition to generating an image, camera application 124 can also be adapted to generate additional imaging data comprising time, date, and geolocation data. As will be discussed further below, some examples are adapted to utilize the additional imaging data to facilitate product management.

Messaging application 122 can be adapted to send an electronic message. In some examples, messaging application 122 can be adapted to send electronic messages of various message types/formats including, but not limited to, SMS, MMS, and/or e-mail messages. Electronic messages can include text and/or images. In some examples, messaging application 122 can be adapted to interface with camera application 124 to allow images and data generated by camera application 124 to be attached/inserted into an electronic message.

Messaging application 122 and camera application 124 can be native applications of electronic devices 120. Significant advantages are provided when system 100 is adapted to facilitate product management using native applications as compared to non-native applications. For example, native applications can be preinstalled on electronic devices 120 as compared to non-native applications that must be downloaded by a user. By leveraging existing native applications of electronic devices 120, for example messaging application 122 and camera application 124, system 100 can spare a user from having to find and download the non-native application which can provide the user both time and cost savings.

It is important to note that some examples of system 100 are designed to not require the user to download an application designed with features for facilitating product management. More specifically, such examples are directed to facilitating product management on applications the user has already downloaded on the phone, regardless of whether the application is native or non-native. For example, the advantages described above with respect to native application can also be afforded to examples where messaging application 122 is non-native but is not designed with features to facilitate product management. This situation can arise where a user, for whatever reason, is unsatisfied with the functionality of the native messaging application and installs a non-native application on their phone. Where system 100 can leverage the non-native messaging application, it still provides the user the time and cost savings associated with not having to download an application with product management features.

These features of system 100 are particularly advantageous when compared to product management solutions that require a user to download a separate, specially designed application to register their product or get customer support. Such applications may need to be bought by the user and may include undesirable advertisements. Moreover, the additional applications may require time consuming maintenance (e.g., user needs to monitor and update the application when necessary). By leveraging pre-existing applications on an electronic device, for example messaging application 122 and camera application 124, the demands on a user are minimized which in turn encourages the user to engage in the product management process. Similarly, product management facilitators employing disclosed systems and methods can be spared the substantial time and costs of developing and maintaining non-native applications.

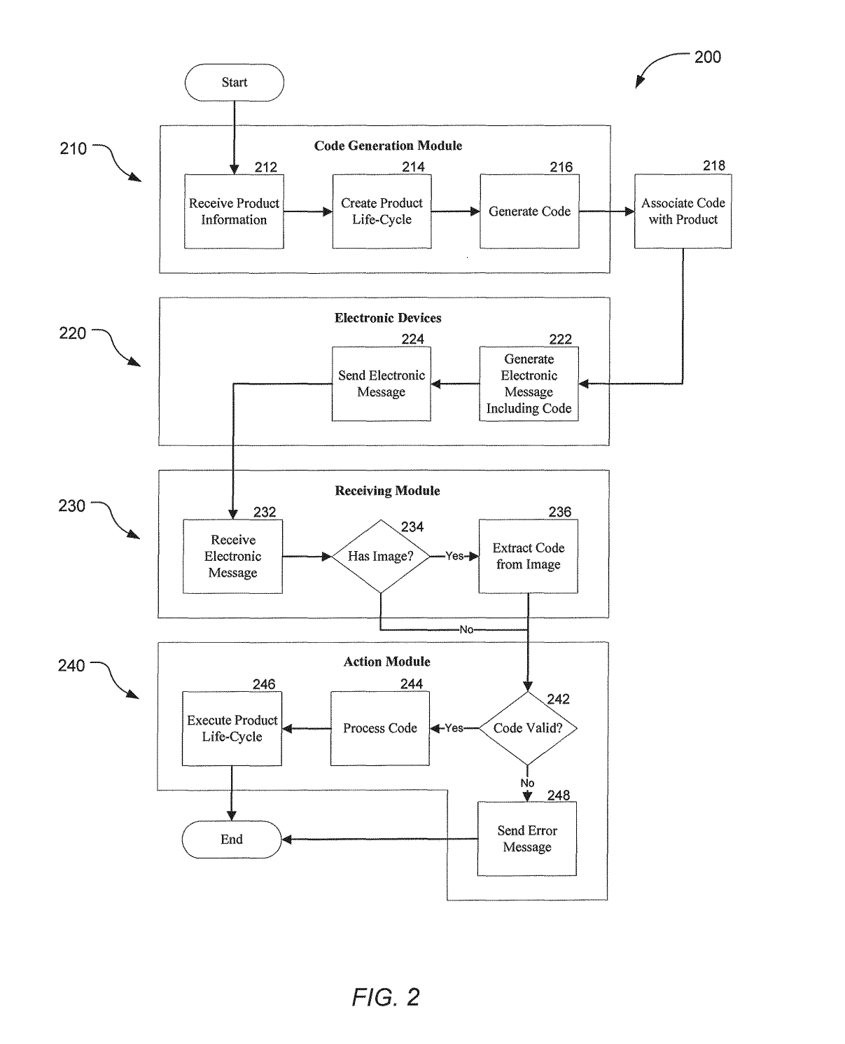

FIG. 2 is a flow diagram illustrating a method 200 for facilitating product management. For example, system 100 of FIG. 1 can be adapted to perform the steps of method 200. In some examples, method 200 can be performed by a code generation module 210, one or more electronic devices 220, receiving module 230, and action module 240.

Code generation module 210 can be adapted to generate a code to help facilitate product management. In some examples, code generation module 210 can be adapted to collect 212 product information, create 214 a product life-cycle, and generate 216 a code based on product information and the product life-cycle.

In some examples, product information includes information useful for product management and/or for identifying a product. For example, product information can include, but is not limited to, a product name, product model, SKU, serial number, MAC address, date of manufacture, origin of product, and/or location of retailer. As will be discussed further below, product information can be used to facilitate product management. It should be appreciated that the quantity and quality of product information can have a significant impact on the ease and degree of customization afforded to a product management system.

Code generation module 210 can also be adapted to create 214 a product life-cycle. Product life-cycles can be used to direct product management. In some examples, a product life-cycle can be created with one or more scopes including, but not limited to, a product type/model, a specific product, and/or a user of a product. In some examples, a product life-cycle can comprise a pre-defined sequence of states through which a product is expected to progress through. In some examples, a product life-cycle can comprise a sequence of executable actions directed to facilitating product management. Product life-cycles are discussed in further detail below.

In some examples, once a code is generated 216 the code can be associated 218 with a product. In some examples, associating 218 a code with a product can include, but is not limited to, affixing a code to a package of the product, on the product itself, and/or in documentation provided with a product. As will be discussed further below, in some examples a tag including the code can be used to associate the code with a product. In some examples a code can be electronically associated with a product by including the code, or a tag including the code, in an e-mail, electronic receipt, splash screen, and/or a suitable electronic user interface or electronic message accessible to the user. As can be appreciated, different considerations can be given in determining how to associate 218 a code with a product. For example, methods which make the code readily visible and accessible to a user is more likely to engage the user in the product management process. Associating a code with a product is discussed in further detail below.

In some examples, after a code is associated 218 with a product one or more electronic devices 220 can be adapted to generate 222 an electronic message including the code to facilitate product management. In some examples, electronic device 220 comprises a smart phone including a native messaging application and a native camera application. In such examples, the smart phone can be adapted to generate 222 an electronic message including the code. For example, a user can send a SMS or MMS message comprising the text of the code using the native messaging application. In a similar example, where the code is affixed to the packaging of a product or on the product itself, a user can use a native camera application to take a picture of the code and send the picture of the code via the native messaging application. Such an example will be discussed in further detail below.

Once the electronic message including the code is generated 222, the electronic device 220 can be adapted to send 224 the electronic message. In some examples, electronic device 220 is adapted to send 224 the electronic device to a web-service which includes the receiving module 230. In such examples, the web-service may be hosted by a computing platform, for example computing platform 103 of FIG. 1. Referring back to FIG. 2, as noted above, in such situations electronic device 220 can comprise a network adapter allowing electronic device 220 to connect to the internet. In another example, electronic device 220 may send 224 the electronic message to the web-service by way of a cellular provider. In such examples, electronic device 220 can send 224 the electronic message to a carrier which then forwards the message to the web-service. In other examples, the carrier can process the electronic message and send the message to gateway, for example a SMS/MMS gateway, and the gateway can implement a call-back service to the web-service.

Receiving module 230 can be adapted to receive 232 an electronic message sent by the electronic device in step 224. In some examples, receiving module 230 receives 232 the electronic message via the internet. In some examples, receiving module 230 is adapted to receive 232 the electronic message by fetching the electronic message from a gateway, for example a SMS/MMS gateway.

Once the electronic message is received 232, receiving module 230 can be adapted to extract 236 the code from the electronic message. In some examples, receiving module 230 is adapted to extract the code from more than one type of electronic message. This feature provides the distinct advantage of allowing a receiving module to accommodate a variety of electronic devices including a variety of applications. Such flexibility allows for more robust product management as receiving module 230 is device and format agnostic and is therefore non-discriminating towards users with unsupported devices or format types. For example, in one situation where an SMS/MMS electronic message is received 232, the code could be embedded in the text of the electronic message, or in an image attached to the message. In such situations, receiving module 230 can be adapted to determine 234 whether the SMS/MMS includes an image to decide how to extract the code. Where the SMS/MMS includes an image, the code can be extracted 236 from the image. As will be discussed further below, in some examples the code is extracted 236 from the image using optical character recognition (“OCR”). Where the SMS/MMS does not include an image, receiving module 230 can be adapted to parse the code directly from the SMS/MMS message. As can be appreciated, a receiving module can be similarly adapted to extract a code from electronic messages of varying types/formats, for example an e-mail.

Once a code has been extracted, action module 240 can be adapted to determine 242 if the code is valid. In some examples, a code can be validated based on the content of the code. For example, as will be discussed further below, action module 240 can be adapted to determine 242 if a code is valid based on a check-sum embedded in the code. In some examples, action module 240 is adapted to determine 242 if a code is valid based on historical data. As noted above, product information and codes can be stored in a database. In such examples, action module 240 can query the database to determine if the code was indeed generated. In some examples, action module 240 can be adapted to determine 242 if a code is valid based on both the content of the code and historical data. In the case that action module 240 determines that a code is invalid, action module 240 can be adapted execute the action of sending 248 an error message to electronic device 220 to prompt the user of the device to resend a message then end method 200. In some examples, the error message sent in step 248 can be an electronic message of the same type/format that was received in step 232.

In the situation where action module 240 determines 242 that the code is valid, action module 240 can be adapted to process 244 the code. In some examples, processing 244 the code is directed to retrieving product information based on the code. In some examples, product information may be stored in a database and action module 240 can be adapted to query the database to retrieve the product information using the code. In some examples, product information may be stored as imaging data included in an image, for example geolocation data generated by a camera application which is informative of a time and location the image was taken. In some examples, product information may be stored in the content of the code (i.e., embedded in the code). In such examples, action module 240 can be adapted to retrieve the product information from the code by, for example, decrypting, decoding, parsing, and/or unpacking the code. Storing product information in the code provides for a number of distinct advantages. For example, this feature can reduce database storage requirements as the data is stored in the code instead of written in the database. While such space savings may seem minimal on a product-by-product basis, it should be appreciated that the cost savings provided by less storage and database maintenance can be significant in the aggregate, for example where method 200 is used facilitate product management of tens or hundreds of thousands of products. As will be discussed further below, in some examples the format of the code can be designed to accommodate holding large amounts or permutations of product information.

In processing 244 the code, action module 240 can also be adapted to determine a product life-cycle associated with the code, as created in step 214. In such examples, action module 240 can be adapted to execute 246 the product life-cycle. In some examples, a product life-cycle can comprise a set of computer readable instructions. In such examples, the product life-cycle may direct action module 240 to automatically perform an action and/or provide instructions to an individual to assist them to manually perform the action. In some examples, executing 246 the product life-cycle includes executing or performing one or more actions. Which action or actions are performed can depend entirely on how the product life-cycle is defined. As noted above, a product life-cycle can comprise a sequence of actions. In such examples, executing 246 the product life-cycle may be to perform the next action in the sequence of action. In some examples, executing an action can include invoking a program module. For example, the next act on in a product life-cycle may be to register a product. In such a situation, executing 246 the product life-cycle can include action module 240 invoking a registration module to facilitate registration of the product. In another example, the next action in the product life-cycle may be to provide a product update. In such a situation, executing 246 the product life-cycle can include action module 240 invoking an update program module to facilitate the product update. In some examples, executing 246 a product life-cycle can comprise taking more than one action and/or invoking more than one program module. Examples of product life-cycles and actions are discussed in further detail below.

A system for facilitating product management can be adapted to repeat some or all of the steps of method 200 until a product life-cycle is complete. For example, system 100 of FIG. 1 can be adapted to initially perform all the steps of method 200 of FIG. 2, then be adapted to repeat steps 222-248 of method 200. More specifically, system 100 of FIG. 1 would be adapted to be continuously responsive to electronic messages sent from a user of an electronic device in connection with a product so long as there are still actions to be performed in a product life-cycle. One advantage of such examples includes providing a simple and streamlined experience for a user to encourage the user to participate in the product management process. Another advantage provided by disclosed systems and methods is the provision of a user-driven product management experience which allows a user to initiate actions in the product life-cycle simply by sending an electronic message. This user-driven experience is especially advantageous when compared to traditional product management methods which include a manufacturer mailing notices to and/or calling a user/customer. An additional advantage provided by the disclosed system and methods is a reduction in cycle time. For example, with reference to FIG. 2, steps 224 through 248 can be automatically performed thereby reducing lag time. As just one example, a user who is registering a product can initiate the registration by sending the electronic message in step 224. Because the remaining steps are automatically executed, the user can receive a response back from the web-service in a matter of seconds. The advantage of decreasing cycle time in executing an action is more evident when compared to traditional product registration methods, for example by mailing in a registration card which can take days or weeks for a response. As can be appreciated, providing systems and methods that substantively reduce wait-time for a customer can have significant market benefits, as well as time and cost savings.

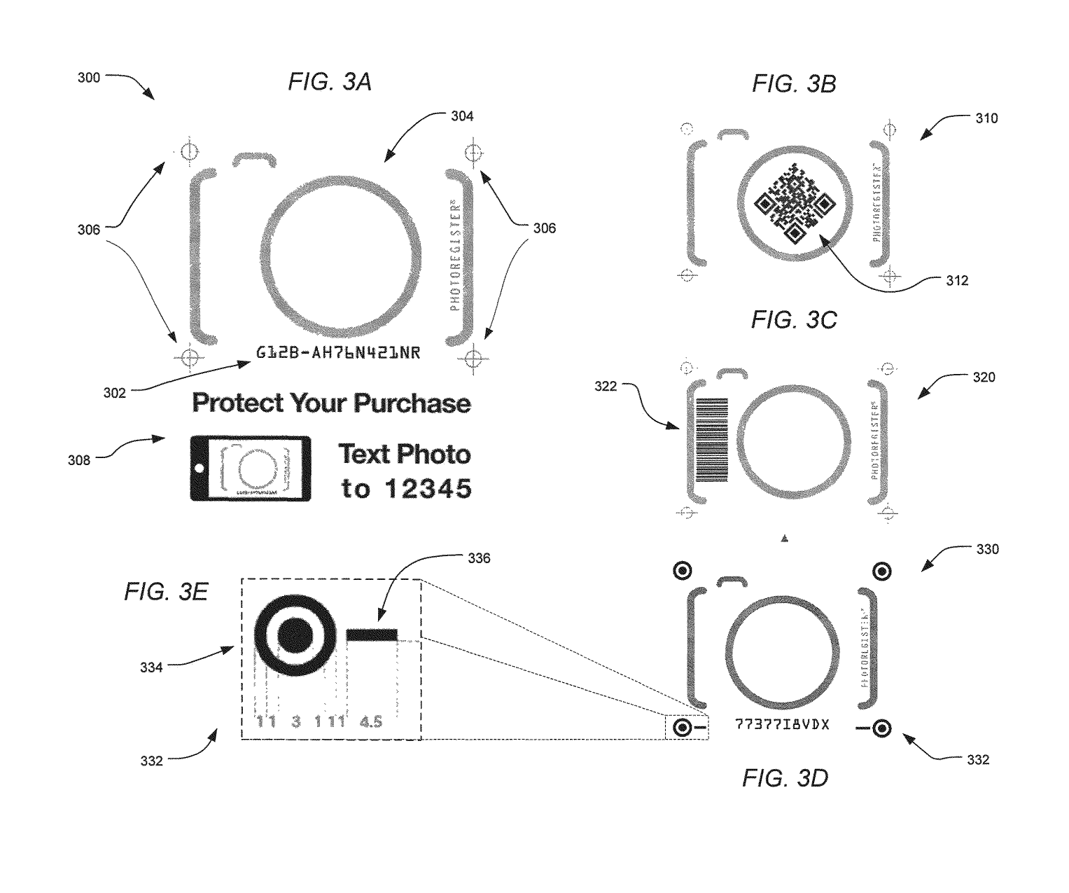

FIGS. 3A-3E provide examples of tags including a code that can be used to associate a code to a product. In some examples step 218 of method 200 in FIG. 2 can be adapted to use one or more of the tags illustrated in FIGS. 3A-3E. FIG. 3A shows tag 300 including code 302 and mark 304. As noted above, tag 300 can be associated with a product, for example, by affixing tag 300 to a product. In some examples, tag 300 can be printed on a sticker which is then placed on a package of a product and/or on the product itself. Tag 300 can also be printed directly on the package and/or the product itself. In such examples, a user/customer or user can take a picture of tag 300 and send it from an electronic device to facilitate product management and/or initiate an action.

As noted above, code 302 of tag 300 can be adapted to include product information. In some examples, code 302 can include product information informative of a brand and source location of a product. In some examples product information of code 302 includes a model, date of manufacture, batch number, SKU and/or serial number. In some examples, code 302 can also include instructions for an action of a product life-cycle. In such examples, an action module can be directed by the code to perform an action of the product life-cycle. As noted above, code 302 can include a check-sum to facilitate validation of the code. This feature is particularly advantages where code 302 includes product information as it helps to assure that the product information is accurate. As just one example, where code 302 includes a serial number of a product and code 302 is used for product registration, validating the code with a check-sum helps to ensure the accuracy of the serial number being registered. This feature also provides the advantage of deterring fraudulent activity (e.g., registering invalid codes) to prevent loss and minimize labor costs.

As noted above, in certain examples, having a robust code design allows for a larger code payload which in turn allows the code to include more product information and/or to be able to represent more products. In this example, the number of characters and character types used to design code 302 allows for 100 quadrillion permutations of the code. In some examples, code 302 can be printed in a font designed to increase precision of reader and/or machine recognition. For example, code 302 can be printed in OCR A Extended font which provides the advantage of accurate machine recognition and easier printing. In some examples, code 302 can also be designed with security features. For example, code 302 can be encrypted and designed using Private Key Infrastructure (PKI) and/or HMAC one-way hashes. Other security features can be implemented a suitable for a particular purpose.

In some examples, code 302 can be printed in a known code format. FIGS. 3B and 3C are examples of tags 310 and 320 that include, respectively, QR code 312 and barcode 322. It can be appreciated that a tag can include a code in any format suitable for a particular purpose including, but not limited to, Micro QR, Aztec, Code One, Data Martix, Databar, UPCA, Postnet, and PDF417.

Referring back to FIG. 3A, tag 300 can also include mark 304. In some examples, mark 304 can be designed to facilitate extraction of code 302. For example, code 302 can include control points 306 which can be used to increase code processing accuracy. In some examples, a receiving module can use control points 306 to derive an orientation and magnitude of tag 300 and/or code 302 which can be useful in decoding codes. For example, the orientation and magnitude of the crosshairs of control points 306 can be provided to a receiving module, which can then process the dimension and orientation of code 302. FIGS. 3D and 3E provide another example of a control point in control point 332. In this example, a receiving module can derive orientation from baseline 336, and magnitude from baseline 336 and the distance between the rings of bullseye 334.

Referring back to FIG. 3A, in some examples, mark 304 can be designed to assist a user in identifying and/or associating code 302 with product management. In this example, mark 30.4 includes a PhotoRegister® trademark. The trademark is shaped like a camera to signal to the user to take a picture of the mark. Mark 304 can also include instruction 308 which informs a user how to use the code. In this example, one of the actions facilitated by code 302 is product registration, so instructions 308 tells the user to “Protect Your Purchase” by texting the code to “12345.” Accordingly, mark 304 can provide the distinct advantage of allowing a user to quickly recognize codes associated with product life-cycles that can be used to facilitate product management, and providing them directions to do so. In some examples, mark 304 can also include a brand of a manufacturer or retailer.

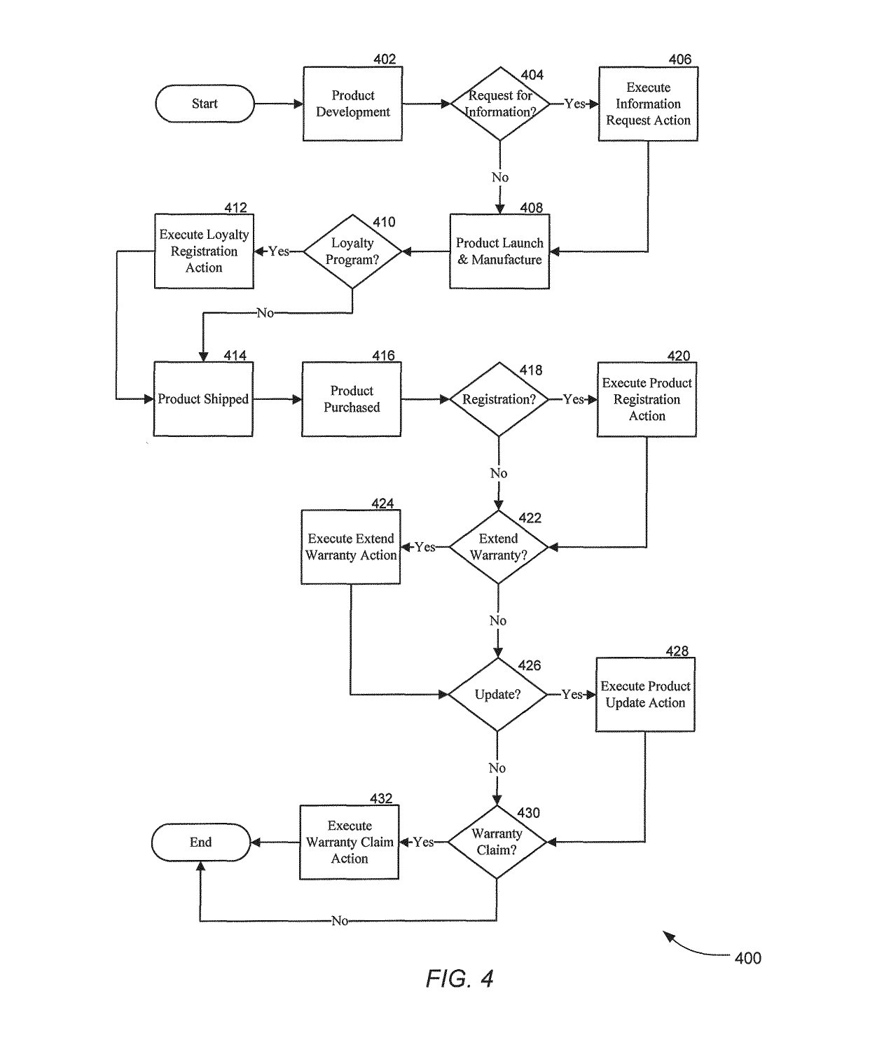

FIG. 4 is a flow diagram illustrating a product life-cycle 400 that can be used to facilitate product management. Product life-cycle 400 can comprise product states and actions for facilitating product management, which can occur before or after purchase of a product. For example, product life-cycle 400 can include a sequence of product states including product development 402, product launch & manufacture 408, product shipped 414, and product purchased 416. Similarly, product life-cycle 400 can include a sequence of actions including executing information request action 406, loyalty registration action 412, product registration action 420, extend warranty action 424, product update action 428, and warranty claim action 432. In some examples, the actions of product life-cycle can be performed in response to a user's action. For example, as discussed above, actions can be performed in response to a user sending an electronic message to a product management system. As can be appreciated, product life-cycle 400 provides only one example. Other examples can include any suitable product states and actions suitable for a particular product or purpose. Similarly, the sequence of states and/or actions can be customizable to suit a particular purpose. For example, as will be discussed below, product life-cycle 400 can be configured to repeat certain actions (e.g., execute product update action 428) where a product requires more than one update during its life-cycle.

Product life-cycle 400 can begin with product development 402 which can comprise research and design of the product. It certain situations, a product can be marketed after and/or during product development 402 but before product launch & manufacture 408. In such situations, consumers can request information 404, for example, by taking a picture of a code on a promotional website and messaging the code to a product management system. A product management system can then execute an information request action 406 which can provide the consumer additional information about upcoming product including, for example, hand-raiser information, development, and/or launch updates.

Similarly, product life-cycle 400 can allow consumers to opt into a loyalty program 410, for example by taking a picture of a code on a manufacture website and/or package and messaging the code to a product management system. The product management system can then execute a loyalty registration action 412 which can provide the consumer loyalty program benefits and other product updates and communications throughout product life-cycle 400.

Product life-cycle 400 can also allow consumers to register a purchased product 418, for example by taking a picture of a code included together with a product and messaging the code to a product management system. The product management system can then execute a product registration action 420 which can gather registration information from the consumer and register the product. In some examples, when a user opts to register for a product 418, product life-cycle 400 can be adapted to make a number of other services available to the consumer. In other examples, these additional services may be available to the consumer even without registration of the product. Additional services can include, for example, extending a product warranty in steps 422 and 424, providing updates to a product in steps 426 and 428, or servicing a warranty claim in steps 430 and 432. As noted above, it should be appreciated that product life-cycle 400 is only one example and that product states and actions can vary to suit a particular purpose or product. Also, as noted above, using a product life-cycle in connection with product management systems and methods, for example system 100 of FIG. 1, and method 200 of FIG. 2, provides distinct advantages of allowing a consumer to actively participate and, in some examples, dictate how a product is managed. For example, steps 404, 410, 418, 422, 426, and 430 of product life-cycle 400 of FIG. 4 can be adapted to be responsive to a user, thereby allowing for a more dynamic and user tailored product experience. Further, increased user participation in product management provides for non-trivial marketing opportunities that can yield monetary benefits.

As noted above, product life-cycles can have different scopes as suitable for a particular purpose. As can be appreciated, the manner in which a product is managed can be dependent on the type of product. For example, an optimal product life-cycle for a highly customized product may differ from an optimal product life-cycle for a mass produced product as each will have different product states and actions. Similarly, certain product life-cycles may have a scope associated with the user of the product. For example, a software vendor managing a software product may employ a product life-cycle for a first corporation and a different product life-cycle for a second corporation because the two corporations have different requirements, needs, infrastructure, etc.

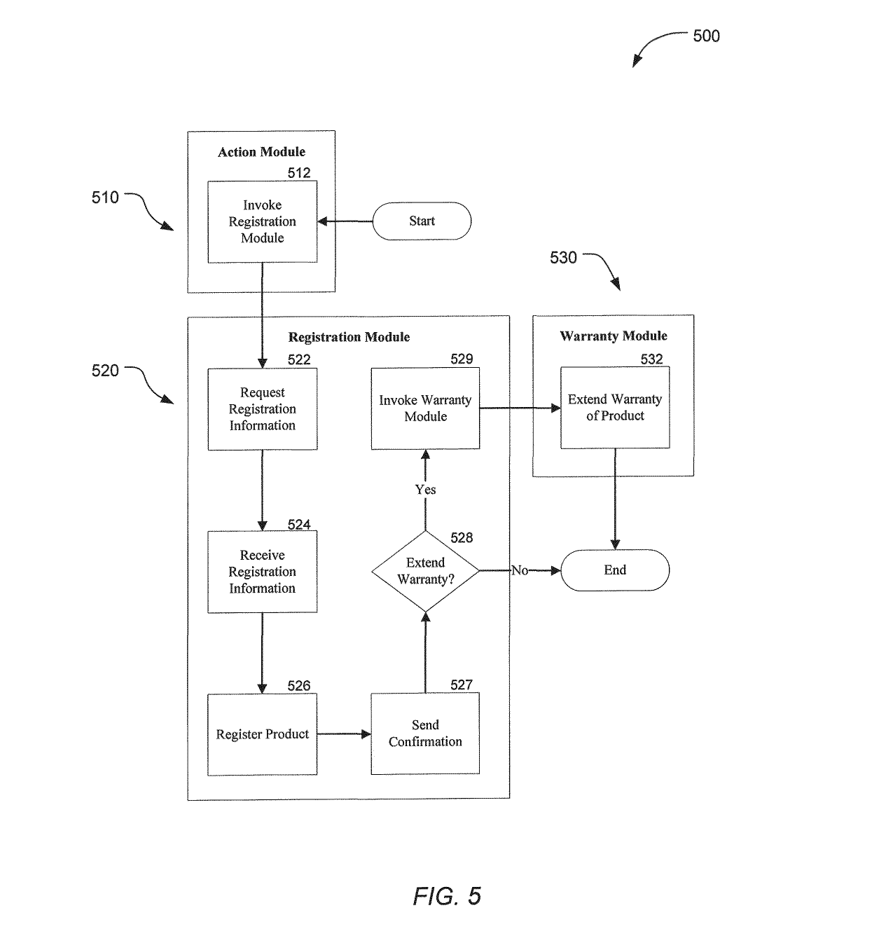

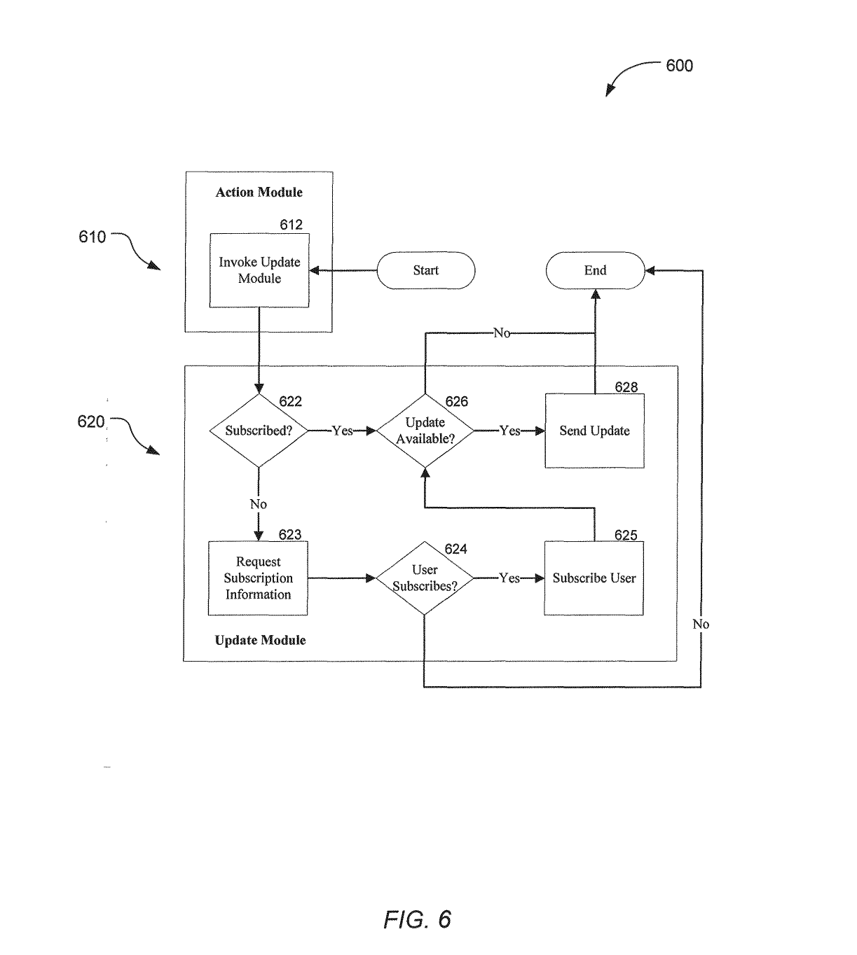

FIGS. 5 and 6 are examples of actions executable by an action module. FIG. 5 is a flow diagram illustrating method 500 adapted to facilitate product registration. In some examples, step 246 of method 200 of FIG. 2 can be adapted to perform method 500 of FIG. 5. With reference to FIG. 5, in some examples action module 510 can be adapted to invoke 512 registration module 520. In some examples, action module 510 is directed by a product life-cycle to only invoke 512 registration module 520 when a product is not yet registered. Once invoked, registration module 520 can be adapted to request 522 registration information from a user. Registration information can include the user contact information and/or product information. In sonic examples, method 500 can be streamlined by embedding all the necessary product information for registration in the code and/or storing the information in a database accessible to registration module 520. Such examples reduce cycle time by minimizing the amount of information a user must provide to register a product and/or limiting the information requested from the user to information the user can readily recall (e.g., the user's contact information).

In some examples, registration module 520 can be adapted to request 522 registration information via a registration message. In some examples, registration module 520 is adapted to determine a source address of the received electronic message (i.e., address of the user's electronic device) and send a registration message to the source address to request the user's registration information. In some examples, the registration message is an electronic message of the same type/format that was initially sent by the user. For example, where the user sends an SMS message for a smart phone, registration module 520 can be adapted to send an SMS message to the user's smart phone. In some examples, the registration message can include a hyper-link to a webpage where the user can enter the registration information. In such examples, the user's electronic device may include a browser to facilitate opening the link and submitting the registration information. In some examples, the browser may be a native application on the electronic device. As noted above, facilitating product registration using native applications on an electronic device provides can provide for both time and cost savings to a user and product management facilitator.

Registration module 520 can be adapted to receive 524 registration information and then register 526 the product. After the product is registered 526, registration module 520 can be adapted to send 527 a confirmation message to the user. As above, the confirmation message can be an electronic message of the same type/format as the one initially sent by the user. In some examples, the confirmation message can be of a pre-determined format being agnostic of the format send by the user.

In some examples, program modules can be adapted to invoke other program modules in accordance with a product life-cycle. For example, a product life-cycle can include an option to extend the warranty of the product. (Warranty extension is a commonly used to incentivize a customer to register a product) In this example, registration module 520 is adapted to determine 528 whether the product life-cycle associated with the product being registered is eligible for an extended warranty. In some examples, determination 528 is made based on a number of parameters defined by the associated product life-cycle, for example, whether there is a promotion and/or whether the product was registered within a certain number of days of purchase. If the product is eligible for an extended warranty, registration module 520 can invoke 529 warranty module 530 to extend 532 the warranty of the product. In other examples, other means can be used to incentivize a user to register a product, for example by providing a coupon and/or a monetary credit to the user. In such examples, registration module 520 can be adapted to invoke one or more program modules suitable for executing the necessary action(s).

FIG. 6 is a flow diagram illustrating method 600 adapted to facilitate product updates. Method 600 can be particularly advantageous when used in connection with electronic products that require periodic upgrades and/or bug fixes. In some examples, step 246 of method 200 of FIG. 2 can be adapted to perform method 600 of FIG. 6. With reference to FIG. 6, in some examples action module 610 can be adapted to invoke 612 update module 620.

Update module 620 can be adapted to initially determine 622 whether a user has subscribed to automatic product updates. If update module determines 622 that a user has not subscribed for updates it can request 623 subscription information from the user. Update module 620 can then determine 624 whether the user agrees to subscribe for product updates. In some examples, update module 620 can determine that a user elects for subscription information when it receives the requested subscription information, at which point update module 620 can be adapted to subscribe 625 the user before proceeding to step 626. In the situation where update module 620 determines 622 that a user has previously subscribed to product updates, update module 620 can proceed directly to step 626.

This feature of method 600 illustrates a distinct advantage of systems and methods directed to product management using codes associated with product life-cycles by allowing for multiple outcomes for identical events. In a simple example, the first time a user sends an image of a tag including a code, method 500 is able to discern that the user has not subscribed for product updates by referencing its associated product life-cycle and tracking the product's progression through the product life-cycle. Similarly, method 500 is able to discern when the user has subscribed (i.e., step 622), using similar methods, before determining 626 if an update is available and sending 628 the update to the user. It is important to note that while disclosed systems and methods can progress through a product life-cycle based on the number of times an electronic message including a code is received, in some examples it is driven by a user's decisions. For example, in method 500 if a user never decides to subscribe, the user will never reach step 626 regardless of the number of electronic messages sent by the user. More specifically, method 500 is illustrative of one example where progression through a product life-cycle is dependent on the substance of a user's action as compared to a number of user actions.

Various examples of the invention have been described. Although the present invention has been described in considerable detail with reference to certain disclosed embodiments, the embodiments are presented for purposes of illustration and not limitation. Other embodiments incorporating the invention are possible. One skilled in the art will appreciate that various changes, adaptations, and modifications may be made without departing from the spirit of the invention and the scope of the appended claims

What is claimed is:

1. A system for registering products comprising:
mobile device comprising native applications, the native applications being adapted to send electronic messages; and
one or more processors; and
one or more computer storage mediums storing program modules adapted to execute on the one or more processors, the program modules comprising
a receiving module adapted to
receive an electronic message from the mobile device, the electronic message comprising a code associated with a product,
extract the code from the electronic message, and
a registration module adapted to register the product based on the code.

2. The system of claim 1, wherein the native applications comprise a native messaging application and a native camera application.

3. The system of claim 1, wherein the code further comprises a graphic.

4. The system of claim 3, wherein the receiving module extracts the code from the electronic message using OCR.

5. The system of claim 4, wherein the receiving module is adapted use the graphic to calibrate OCR.

6. The system of claim 1, wherein the code comprises a serial number associated with the product.

7. The system of claim 1, wherein the program modules further comprise an action module, the action module being adapted to
determine if the product has been previously registered based on the code,
invoke the registration module to register the product if the product has not yet been registered.

8. The system of claim 1, wherein the registration module is adapted to register the product by
sending a registration message to the mobile device, the registration message including a request for registration information to electronically register the product,
receiving the registration information from the mobile device,
registering the product based on the registration information.

9. The system of claim 1, wherein the electronic message is an MMS or SMS message.

10. The system of claim 8, wherein the registration message and the electronic message are of the same message type.

11. The system of claim 1, wherein the system further comprises a gateway adapted to receive and forward SMS and MMS messages from the mobile device, and the receiving module is adapted to receive the electronic message from the mobile device via the gateway.

12. The system of claim 1, wherein the electronic message sent from the mobile device is not sent using a non-native application designed to facilitate product registration.

13. A system comprising:
one or more product life-cycles, each product life-cycle including a sequence of actions;
one or more databases including historic data;
one or more processors; and
one or more computer storage mediums storing program modules adapted to execute on the one or more processors, the program modules comprising
a receiving module adapted to
receive an electronic message, the electronic message comprising a code associated with a product life-cycle,
extracting the code from the electronic message,
an action module adapted to
receive the code from the receiving module,
determine the product life-cycle associated with the code,
determine a next action based on a sequence of actions of the product life-cycle and historic data associated with the code, and
execute an action based on the sequence of actions.

14. The system of claim 13, wherein the sequence of actions is associated with a product type.

15. The system of claim 13, wherein the code comprises a product ID and the sequence of actions is associated with the product ID.

16. The system of claim 13, wherein the sequence of actions is associated with a user of a. product.

17. The system of claim 13, wherein the action module is further adapted to modify the product life-cycle by adding or subtracting one or more actions to the sequence of actions of the product life-cycle.

18. The system of claim 13, wherein the action module is further adapted to make a determination as to whether the action is executed successfully and either repeat the action or advance the sequence of actions based on the determination.

19. The system of claim 13, wherein the action module executes the action based on the sequence of actions by invoking one of the program modules associated with the action.

20. The system of claim 13, wherein the program modules further comprise a registration module adapted to register a product based on the code.

21. A method comprising:
receiving an electronic message comprising a code associated with a product life-cycle;
extracting the code from the electronic message;
determining the product life-cycle associated with the code, the product life-cycle including a sequence of actions, and
advancing through the sequence of actions in response to receiving the electronic message.
